(19) United States
(12) Patent Application Publication
(10) Pub. No.: US 2007/0239529 A1
(43) Pub. Date: Oct. 11, 2007

(54) Targeting and/or scoring advertisements using information derived from called telephone numbers or the called telephone numbers themselves

(76) Inventors: Shumeet Baluja, Santa Clara, CA (US); Michael Chu, Los Altos Hills, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/393,384

(22) Filed: Mar. 30, 2006

(51) Int. Cl. G06Q 30/00

(52) U.S. Cl. 705/14

(57) ABSTRACT

Called telephone number(s) from a client device are stored. The called number(s) is used to lookup information related to the called number(s) (e.g., a name and address). Additional information might be obtained about the called party including the type of business, classifications of the products of the business, etc. This information may then used to select and/or store advertisements to serve to the client device (or to the user of the device, if known, when that user is on another device such as a Web device). Advertisements can be scored according to how well they match the information derived from the called telephone number(s).

### §1. BACKGROUND OF THE INVENTION

§1.1 Field of the Invention

The present invention concerns advertising, such as online advertising for example. In particular, the present invention concerns helping an advertising system to serve more relevant ads.

§1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif. (referred to as “Google”), delivers ads targeted to keywords from search queries. Similarly, content targeted ad delivery systems have been proposed. For example, U.S. patent application Ser. Nos. 10/314,427 (incorporated herein by reference and referred to as “the '427 application”), titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and 10/375,900 (incorporated by reference and referred to as “the '900 application”), titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

As can be appreciated from the foregoing, serving ads relevant to concepts of text in a text document and serving ads relevant to keywords in a search query are useful because such ads presumably concern a current user interest. Consequently, such online advertising has become increasingly popular. However, it would be useful to serve more appropriate and relevant ads, particularly ads targeted considering alternative information (e.g., when a search query or a rendered document is not available), or additional user information.

### §2. SUMMARY OF THE INVENTION

Embodiments consistent with the present invention may improve the usefulness of advertisements. Such embodiments may do so by (a) storing a set of one or more numbers called by a client device, (b) determining call-derived information using the stored set of one or more called numbers, and (c) determining a set of one or more ads to serve using the determined call-derived information.

In at least some embodiments consistent with the present invention, the act of determining call-derived information includes using the stored set of one or more called numbers to look up directory information (which might include a business name, an organization name, a person's surname, or a person's given name) of the called party.

In at least some embodiments consistent with the present invention, the act of determining call-derived information further includes using the directory information to determine related information (e.g., using information inference, information expansion, etc.).

In at least some embodiments consistent with the present invention, the act of determining call-derived information includes weighting the call-derived information, and the act of determining a set of one or more ads to serve uses the determined weighted call-derived information. The call-derived information might be weighted using (A) a duration of a call from which the call-derived information was determined, (B) a cost of a call from which the call-derived information was determined, (C) a frequency that a called number was called, from which the call-derived information was determined, (D) a time lapsed since the call, from which the called-derived information was determined, was last called, (E) a frequency of calls to the same number, (F) a number of calls to the same number, (G) a frequency of calls to a type of person, (H) a frequency of calls to a type of organization, (I) a frequency of calls to a type of business, (J) a number of calls to a type of person, and (K) a number of calls to a type of organization, and/or (L) a number of calls to a type of business.

In at least some embodiments consistent with the present invention, the act of determining call-derived information includes determining a location from the area code of at least one of the stored set of one or more called numbers.

The called numbers from the set of called numbers might include a telephone number, and/or a short message service number.

In at least some embodiments consistent with the present invention, the act of determining a set of one or more ads to serve using the determined call-derived information includes matching terms of the call-derived information with targeting keywords associated, as a serving constraint, with an advertisement to be served.

### §3. BRIEF DESCRIPTION OF THE DRAWINGS

FIG. 1 is a diagram showing parties or entities that can interact with an advertising system.

FIG. 2 is a diagram illustrating an exemplary environment in which, or with which, embodiments consistent with the present invention may operate.

FIG. 3 is an example illustrating operations in an exemplary embodiment consistent with the present invention.

FIG. 4 is a flow diagram of an exemplary method for performing exemplary operations in a manner consistent with the present invention.

FIG. 5 is a bubble diagram of exemplary operations that may be performed in a manner consistent with the present invention, as well as information that may be used and/or generated by such operations.

FIG. 6 is a block diagram of an exemplary apparatus that may perform various operations and store various information in a manner consistent with the present invention.

FIG. 7 illustrates an exemplary data structure for storing called numbers and call derived information in a manner consistent with the present invention.

FIG. 8 illustrates an exemplary data structure for storing information related to called telephone numbers in a manner consistent with the present invention.

FIG. 9 illustrates an exemplary data structure for storing user profile information in a manner consistent with the present invention.

### §4. DETAILED DESCRIPTION

The present invention may involve novel methods, apparatus, message formats, and/or data structures for determining ads to serve to ad recipients using one or more called telephone numbers or information derived from (e.g., related to) one or more called telephone numbers. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. Where only one item is intended, the term “one” or similar language is used. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventors regard their invention to include any patentable subject matter described.

In the following definitions of terms that may be used in the specification are provided in §4.1. Then, environments in which, or with which, the present invention may operate are described in §4.2. Exemplary embodiments of the present invention are described in §4.3. Thereafter, specific examples illustrating the utility of exemplary embodiments of the present invention are provided in §4.4. Finally, some conclusions regarding the present invention are set forth in §4.5.

### §4.1 DEFINITIONS

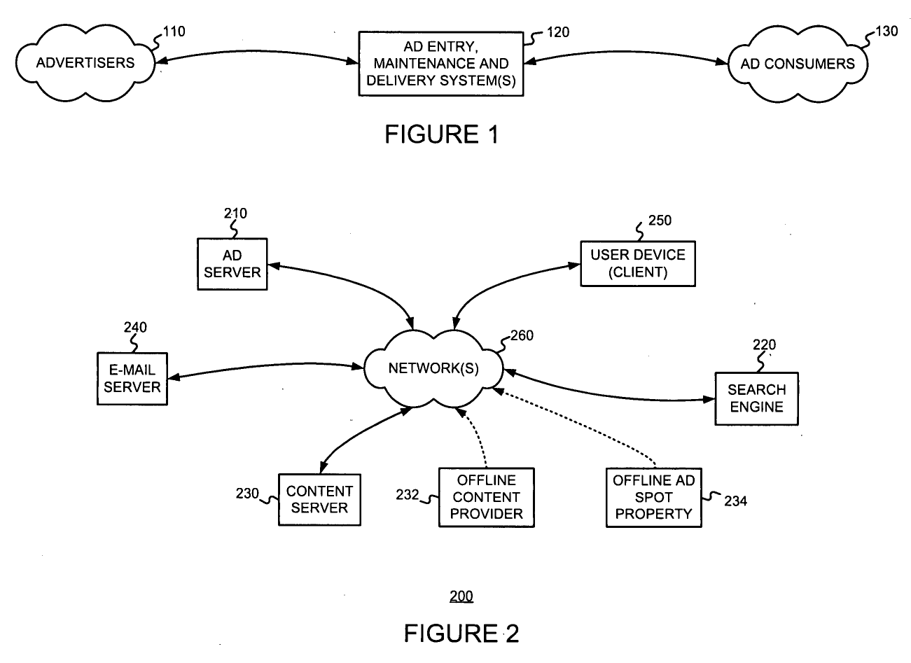

Online ads, such as those used in the exemplary systems described below with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). Targeting criteria can be broad or narrow. For example, in some systems, an advertiser may be able to narrow the targeting of the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate” or “CTR”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online (e.g., entered by offline property owner). For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.) so that an ad targeting system can provide it with relevant ads for presentation at the music festival.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page. A Website may include multiple Web pages.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat PDF reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

### §4.2 EXEMPLARY ADVERTISING ENVIRONMENTS IN WHICH, OR WITH WHICH, THE PRESENT INVENTION MAY OPERATE

FIG. 1 is a diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 230 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geolocation information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

The offline content provider 232 may provide information about ad spots in an upcoming publication, and perhaps the publication (e.g., the content or topics or concepts of the content), to the ad server 210. In response, the ad server 210 may provide a set of ads relevant to the content of the publication for at least some of the ad spots. Examples of offline content providers 232 include, for example, magazine publishers, newspaper publishers, book publishers, offline music publishers, offline video game publishers, a theatrical production, a concert, a sports event, etc.

Owners of the offline ad spot properties 234 may provide information about ad spots in their offline property (e.g., a stadium scoreboard banner ad for an NBA game in San Antonio, Tex.). In response, the ad sever may provide a set of ads relevant to the property for at least some of the ad spots. Examples of offline properties 234 include, for example, a billboard, a stadium score board, and outfield wall, the side of truck trailer, etc.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

### §4.3 EXEMPLARY EMBODIMENTS

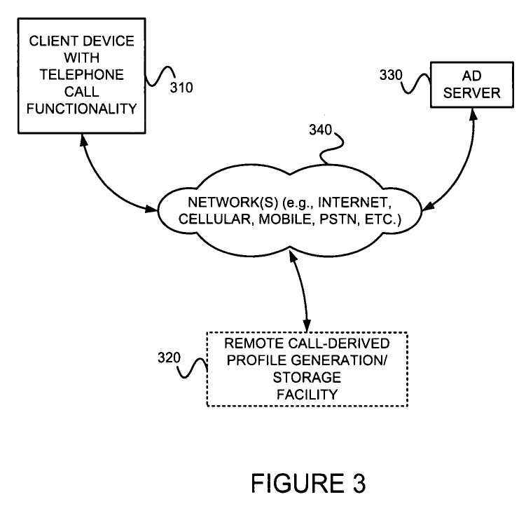

FIG. 3 is an exemplary environment in which exemplary embodiments consistent with the present invention may operate. The environment includes a client device 310 with telephone call functionality, an ad server 330, and perhaps remote call-derived profile generation/storage facility 320, all of which may communicate with one another via one or more networks 340, such as the Internet for example. The client device 310 may also be able to transmit and/or receive data via network(s) 340. The telephone, cellular, Internet, and/or other network(s) are represented, collectively, by cloud 340.

In general, for purposes of generating a call-based profile in a manner consistent with the present invention, the client device 310 may be any device that can make a telephone call (and perhaps store called numbers). In general, for purposes of rendering an ad targeted using a previously generated call-derived profile, the client device 310 may be any device that can receive and render an ad (which might be, for example, audio ads, voice ads, SMS ads, Website ads, etc.). Thus, examples of client devices 310 include desktop computers (e.g., with Voice Over Internet Protocol (VOIP) functionality), portable telephone handsets and/or mobile telephones (e.g., that can access (and browse) the Internet), personal digital assistants (PDAs) (e.g., that can make telephone calls and/or access (and browse) the Internet), and client devices that can receive text or voice messages, just to name just a few.

When a number is called (e.g. to establish a telephone call or to send an short message service (SMS) message) from client device 310 for transmission over the network(s) 340, client device 310 can (A) either record and save the dialed number, and/or (B) transmit the dialed number (either directly or indirectly) to a remote facility 320 which will record and store the number dialed in association with some identifier of the client device 310. Remote facility 320 may then advantageously use the dialed number to look up information related to the dialed number from various databases. This extracted information may help to select ads to be served from the ad server 330 to the client device 310 (or another device associated with the user of the client device 310). For instance, the related information may be keywords, which could be matched with similar keywords used to target ads.

Suppose, for example, that the client device 310 was used to call a movie theater. The number dialed could be stored. A reverse-directory lookup could then use the stored number to determine that a “movie theater” was called. Ads associated with movie theaters, movies, DVD's, home theater electronic systems, etc., could be directed to client device 310 (or to the user of client device 310, if known, on another client device used to access the Internet) in the future.

It should be understood that the call-derived information determination could be accomplished at facility 320 and/or at an alternative location. Likewise, the information gathered relating to the called (e.g., dialed) number could be stored at facility 320 or at various other places.

§4.3.1 Exemplary Methods

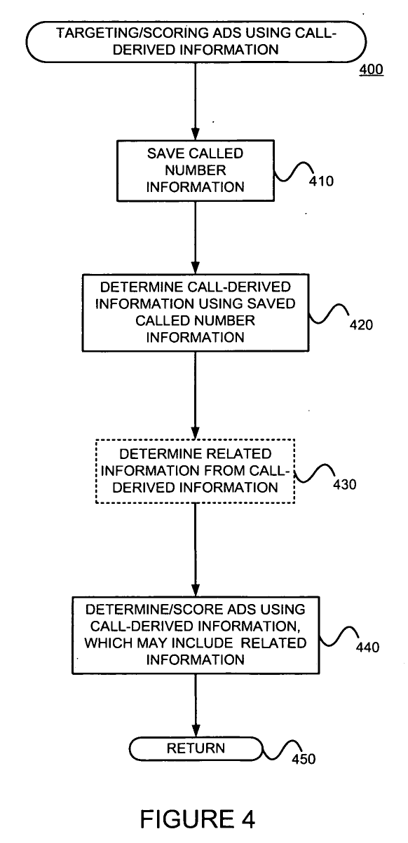

FIG. 4 is a flow diagram of an exemplary method 400 for targeting and/or scoring ads using call-derived information in a manner consistent with the present invention. More specifically, method 400 describes techniques to target and/or score ads, to be presented to the user, using call-derived information such as the use of dialed numbers to look up related information described above in relation to FIG. 3.

The called number (e.g. to establish a telephone call or to send an SMS message) information is stored. (Block 410) This called number information is then used to determine information derived from the dialed number(s), such as geographic location(s) of the called number(s), name(s) of person(s) called, name(s) of business(es) called, names of organization(s) called, type(s) of business called, type(s) of organization(s) called, etc. (Block 420) Optionally, further information related to the derived information of block 420 may be determined. (Block 430)

A set of one or more ads may then be determined and/or scored using the call-derived information (which may include the related information) (Block 440) before the method 400 is left (Node 450). For example, ads might be determined and/or scored according to the closeness of their serving constraints (e.g., keywords) to the call-derived information (which may include related information) (e.g., number of common terms, etc.).

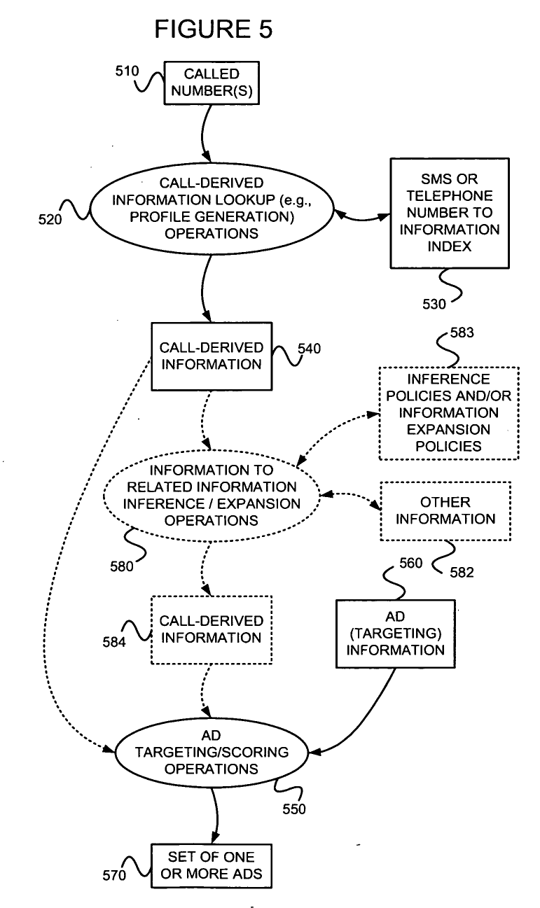

FIG. 5 is a bubble diagram of exemplary operations that may be performed in a manner consistent with the present invention, as well as information that may be used and/or generated by such operations. The numbers 510 called from client device 310 are stored. Database 530 uses SMS and/or telephone numbers to index associated information for each number (location, name of person, business or organization, type of business or organization, etc.). Call-derived information lookup (e.g., profile generation) operations 520 may accept, the called number(s) 510 and use them to lookup related information in index 530, to obtain call-derived information 540. This information 540 may be transient, or may be used to build (or add to) a profile for a client device (and/or the user of a client device, if known). In a simple case, operations 520 might use techniques similar to a reverse yellow page lookup. However, information can be obtained for more than one called number, and may be used for different purposes (described below).

The call-derived information 540 could be used by information-to-related information inference/expansion operations 580 to determine further call-derived information 584 using other information 582 and perhaps inference policies and/or information expansion policies 583, etc. For instance, the call-derived information 540 might include the name of a hotel considered to serve an upscale market segment, whereas the associated information 582 might contain information associated with that hotel (e.g., golf, tennis, spa, hiking, fishing, etc.). This additional information 584 may be added to the profile of the client device (and/or the user of the client device, if known).

The ad targeting/scoring operations of 550 can use the call-derived information 540, perhaps supplemented by further call-derived information 584, to select a set of one or more ads 570 using ad (targeting) information 560. This could advantageously be done using existing technology (e.g., AdSense by Google) by building a page document containing a string of the keywords in the profile (such as the store names and categories of the stores called by the user). Although such a page document might not make sense for a person to read, it could be used by ad targeting mechanisms (such as Google's AdSense technology) to determine potential ads to be served.

Other profile information of the page document might include descriptions of the called stores inferred from the stores' Websites. For example, a store's Website can be automatically determined (e.g., the store might have provided their Website if they are an advertiser, a search engine might be used to query the store name (often, if the store has a Website, it comes up as a search result when the store's name is searched; and for regional queries, the store's name and the region (e.g., city, state, zip, etc.) might be queried), the store Website might be stored in a reverse lookup index mapping a telephone number to a store name, address and Website, etc.). Thus, using a phone number, a reverse yellow page-like lookup may be performed to find a business name. Using the business name, its Website might be discovered, as described above. Finally, content from the store's Website (or a summary of the store's Website) might then be added to the user's profile. Techniques used creating summaries, such as those described in Mandar Mitra, Amit Singhal, Chris Buckley, “Automatic Text Summarization by Paragraph Extraction,” Proceedings of the ACL Workshop on Intelligent and Scalable Text Summarization, pp. 39-46 (1997), Inderjeet Mani, Mark T. Maybury (Editors), Advances in Automatic Text Summarization, MIT Press (July 1999), etc., may be used for creating a summary of the Website.

The set of (one or more) ads 570 could advantageously be presented to the client device that called the numbers 510, or to the user of the client device (e.g., when using a different device, such as a device connected to the Internet, via an offline property, etc.). As can be appreciated from the foregoing, these ads could be determined and/or scored using information derived from the number(s) called from the client device.

§4.3.2 Exemplary Apparatus

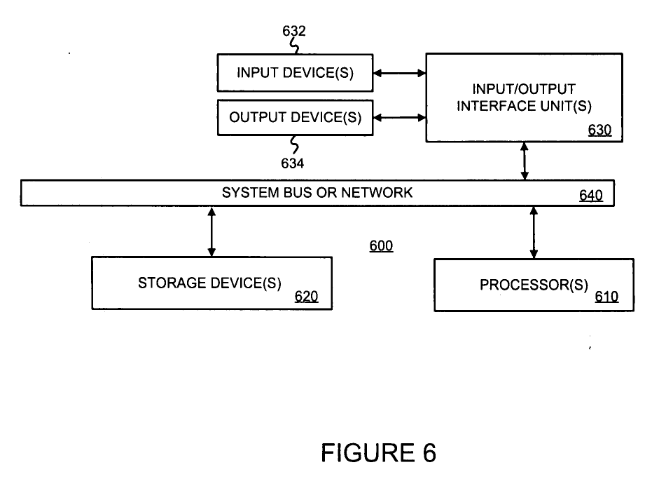

FIG. 6 is high-level block diagram of a machine 600 that may perform one or more of the operations and store various information described above. The machine 600 basically includes one or more processors 610, one or more input/output interface units 630, one or more storage devices 620, and one or more system buses and/or networks 640 for facilitating the communication of information among the coupled elements. One or more input devices 632 and one or more output devices 634 may be coupled with the one or more input/output interfaces 630.

The one or more processors 610 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C., mobile client applications developed using various commercially available platforms such as Binary Runtime Environment for Wireless ((BREW) from Qualcomm of San Diego, Calif.), Java 2 Micro Edition ((J2ME) from Sun of Santa Clara, Calif.), Symbian, Smartphone, etc.) to effect one or more aspects of the present invention. At least a portion of the machine executable instructions may be stored (temporarily or more permanently) on the one or more storage devices 620 and/or may be received from an external source via one or more input interface units 630.

In one embodiment, the machine 600 may be one or more conventional personal computers. This computer might support VoIP telephony and/or Internet browsing. In this case, the processing units 610 may be one or more microprocessors. The bus 640 may include a system bus. The storage devices 620 may include system memory, such as read only memory (ROM) and/or random access memory (RAM). The storage devices 620 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media. The machine 600 may be a mobile telephone. The machine 600 may be a PDA.

A user may enter commands and information into the personal computer through input devices 632, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 610 through an appropriate interface 630 coupled to the system bus 640. The output devices 634 may include a monitor or other type of display device, which may also be connected to the system bus 640 via an appropriate interface. In addition to (or instead of) the monitor, the personal computer may include other (peripheral) output devices (not shown), such as speakers and printers for example.

Referring back to FIG. 3, each of the client device 310, facilities 320 and the ad server 330 might be implemented using one or more machines 600.

§4.3.3 Refinments, Alternatives and Extensions

The present invention is not limited to the specific examples provided above. Examples of types of call-derived information, how such information is determined, where such information is stored, how such information is used, etc., are described below.

§4.3.3.1 Types of Call-Derived Information and How They are Generated

Information that might be derived from called numbers (e.g., telephone numbers, SMS numbers, etc.) might include one or more of a business name, an individual's name, an organization's name, a location (e.g., an area code), etc.

Various techniques may be used to expand this information. For example, a business name may be used, in conjunction with a yellow page listing, to determine the type of business (e.g., Best Buy->electronics retailer, Dick's->sporting goods, Lowes->Home Improvement, etc.). As another example, a business name may be used, in conjunction with databases, to determine services offered by the business (e.g., Midas->car service, mufflers, brakes, oil change, . . . ) and/or products offered by the business (e.g., Eddie Bauer->{inventory}). As yet another example, a person's given name or surname may be used, in conjunction with etymological knowledge to determine nationality and/or ethnicity information (e.g., Perez->Spanish, Chow->Chinese, Miller->English, Xanthopoulos->Greek, Petrov->Russian, Hashimoto->Japanese, Sudano->Italian, Patel->Indian, Beck->German, O'Hara->Irish, etc.). As still another example, a place called can be used, in conjunction with available information, to expand this information (e.g., Orlando, Fla.-> Disney, family vacations, . . . , Bentonville, Ak.-> WalMart, retailing, . . . , Las Vegas, Nev.-> gambling, shows, . . . , etc.). For example, the term “Orlando, Fla.” might be entered as a search query and the top (N) search results could be analyzed to determine related information. As another example, the term “Orlando, Fla.” might be entered as a search term in an online encyclopedia and an entry, if any, could be analyzed to obtain related information. Similar information expansion techniques can be applied to other “seed” information such as a business name, an organization name, a person's name, etc.

Topic detection and clustering techniques may be used to determine related information. Techniques such as those described in James Allan (Editor), Topic Detection and Tracking: Event-based Information Organization (The Kluwer International Series on Information Retrieval, Volume 12) (The Information Retrieval Series), Springer (Feb. 1, 2002), Jonathan G. Fiscus, George R. Doddington, “Topic Detection and Tracking Evaluation Overview,” The Kluwer International Series On Information Retrieval Topic Detection and Tracking: Event-Based Information Organization, pp: 17-31, Kluwer Academic Publishers, Norwell, Mass. (2002), Christopher Cieri, Stephanie Strassel, David Graff, Nii Martey, Kara Rennert, Mark Liberman, “Corpora for Topic Detection and Tracking,” The Kluwer International Series On Information Retrieval Topic Detection and Tracking: Event-Based Information Organization, pp. 33-66, Kluwer Academic Publishers, Norwell, Mass. (2002), etc., may be used to obtain related information.

Inferences may be made to expand the called derived information. For example, an economic stratum of the caller (a call to a Motel 6 or a Kia dealer versus a call to a Four Seasons Hotel or a Mercedes dealer) could be determined by further classification and/or analysis. For example, the average price of the products sold by the merchants or the average selling price of the products produced by the manufacturers (perhaps normalized to the prices of similar products—$15,000 is inexpensive for a new car, but is expensive for a watch) can be analyzed. As another example, the mean income (e.g., from the US census data bureau) of the locations of the places that are called can be analyzed.

This information may be weighted. For example, the cost of the telephone calls associated with call-derived information might be used to weight such information (e.g., higher cost might evidence a more important call and therefore a higher weight). As another example, the duration of the calls associated with call-derived information might be used to weight such information (e.g., longer duration might evidence a more important call and therefore a higher weight). As yet another example, if the time and/or date of the telephone call was saved, the amount of time elapsed since the call associated with the call-derived information might be used to weight such information (e.g., a plumber was called yesterday versus last year). As still another example, information derived directly from the called-telephone number (e.g., a person's name, a business name, a location, etc.) might be weighted more heavily than further information derived from (e.g., by inference, by information expansion, etc.) such information. As still yet another example, the number and/or frequency of telephone calls to a particular person might be used in weighting information. For example, if a person calls a plumber ten (10) times in one day, this might be more meaningful than if a person calls a restaurant twice a week. Such frequencies might be first normalized per called number and/or per business type. For example, if business A typically receives one (1) call per month from a typical caller, and business B typically receives 20 calls per month from a typical caller, the fact that the particular caller called business A five (5) times in the last month might be weighted more heavily than the fact that the particular caller called business B five (5) times in the last month.

In at least some embodiments consistent with the present invention, the frequency does not need to be for a particular person or business, but can be tracked for a type or class or person (e.g., people in Mountain View, Calif.) or business (e.g., restaurants).

Weights, such as those just described, might be used to prune information where storage, communication, and/or processing of too much information are concerns.

Key presses responsive to voice message system prompts may be used to generate call-derived information. As an example of using such key presses, instead of simply noting that the user called a local theater, by analyzing the voice prompts (which might have been previously crawled (e.g., a list of numbers of voice message systems could be called and crawled by entering numbers) and analyzed (e.g., using speech recognition for example)) and responsive key press responses, it might be learned that the user was interested in a specific movie (“Finding Nemo” versus “The Matrix”), not just that they called a movie theater. This could result in ads being served related to that specific movie, or based on the genre of the movie (e.g., children's movies versus action and science fiction movies). Such a system may require a device that would call dialed numbers (that were followed with further dialed digits), and utilizing speech recognition technology, learn which terms were associated with each of the possible choices.

§4.3.3.2 Storage of Call-Derived Information

Call-derived information (e.g., a user profile) may be stored on the client device and/or remote from the client device. For instance, “light-weight” profile information (e.g., a type of business or a business location corresponding to a called number, the name of a called person, the called numbers themselves, etc.) might be stored locally on the client device. As another example, “heavy-weight” profile information might be more advantageously (determined and) stored at a (e.g., central) location remote from client device.

Although the called numbers of a client device were described as being stored on the client device in exemplary embodiments consistent with the present invention described above, called numbers might be obtained from a source other than the calling device instead, or in addition. For example, called numbers of client device might be obtained from a telephone company for example. These called numbers could be used as described above.

Light-weight profiles could be uploaded from the client device from time to time to update heavier-weight profiles at a remote facility. In at least some embodiments consistent with the present invention, either profile (or both profiles) could be used, depending on the context in which ads are to be served

§4.3.3.3 Use of Call-Derived Information in Targeting Ads

In at least some embodiments consistent with the present invention, call-derived information (e.g., a client device profile or user profile) might be used to determine relevant ads and/or to score ads. If the profile includes weighted keywords, ad scoring could consider these weights. Alternatively, or in addition, called-derived information might be matched with targeting information of ads by clustering or grouping techniques well known in the advertising industry, by thesaurus lookups, synonym lookup, etc. The above techniques could also be used to filter out determined keywords that might be less relevant, particularly if storage or computing capability limitations are of concern.

The performance of ads served by call-derived information targeting can be tracked in order to further improve ad serving. For instance, selection (e.g., click-through) rates, conversion (e.g., call-through) rates, etc., might be monitored to determine which ads are most effective in various environments, and/or to determine what called-derived information and/or type of call-derived information is the most useful in determining and/or scoring ads. In at least some embodiments consistent with the present invention, such performance information might be used to weight and/or prune called-derived information.

Call-through rates might be determined by comparing the called numbers from the client device with the telephone numbers associated with ads served to the client device.

It should be understood that the ads selected according to embodiments consistent with the present invention might be served in a variety of ways. For instance, the ads could be textual or audio. As another example they could be briefly shown or constant (as a screen-saver on a handheld device). As yet another example, they could be served immediately after the called number is dialed or at a future time. As still another example, they could be served on the client device or on any device associated with (the user of) the client device.

§4.3.3.4 When Call-Derived Information is Generated

In most of the exemplary embodiments described above, call-derived information was determined in advance of generating an ad request. However, in at least some embodiments consistent with the present invention, the client device might simply store called numbers (e.g., as a light-weight profile) and an ad request might include one or more of the stored, called, numbers. These numbers could be used to determine call-derived information (e.g., in real-time), and perhaps related information, which might then be used to determine and/or score ads.

Thus, locally stored called numbers can be used in a real-time two-step look up. First, the called telephone numbers are used to look up and/or determine call-derived information (e.g., at the client device, and/or (preferably) at a remote facility). Second, the call-derived information looked up or determined in real time might be used to determine and/or score ads. This might require more real-time processing but might permit a more compact profile.

§4.3.3.5 Business Methods

Referring back to FIG. 3, the entity controlling the ad server (referred to as “the ad serving entity”) may have a business or commercial relationship with not only advertisers, but also the end user of the client device and/or a telephone service provider (e.g., mobile, cell, VoIP, legacy, etc.). In at least some embodiments consistent with the present invention, the ad serving entity might obtain the called numbers from the user of the client device. In such embodiments, the ad serving entity might use advertising revenues to pay the user, to subsidize telephone service costs normally paid by the user, and/or to subsidize telephone equipment (e.g., client device) costs normally paid by the user. In at least some embodiments consistent with the present invention, the ad serving entity might obtain the called numbers from the telephone service provider (e.g., subject to appropriate user permission/authorization). In such embodiments, the ad serving entity might use advertising revenues to pay the telephone service provider, to subsidize telephony service costs normally borne by the telephone service provider, and/or to subsidize telephone equipment costs normally borne by the telephone service provider. In at least some embodiments consistent with the present invention, the ad serving entity might obtain the called numbers from means installed on the client device (e.g., subject to appropriate user permission/authorization) by the client device manufacturer, by the telephone service provider and/or by a third party. In such embodiments, the ad serving entity might use advertising revenues to pay such a party, and/or to subsidize telephone client device costs.

### §4.4 EXAMPLE OF OPERATIONS IN AN EXEMPLARY EMBODIMENT CONSISTENT WITH THE PRESENT INVENTION

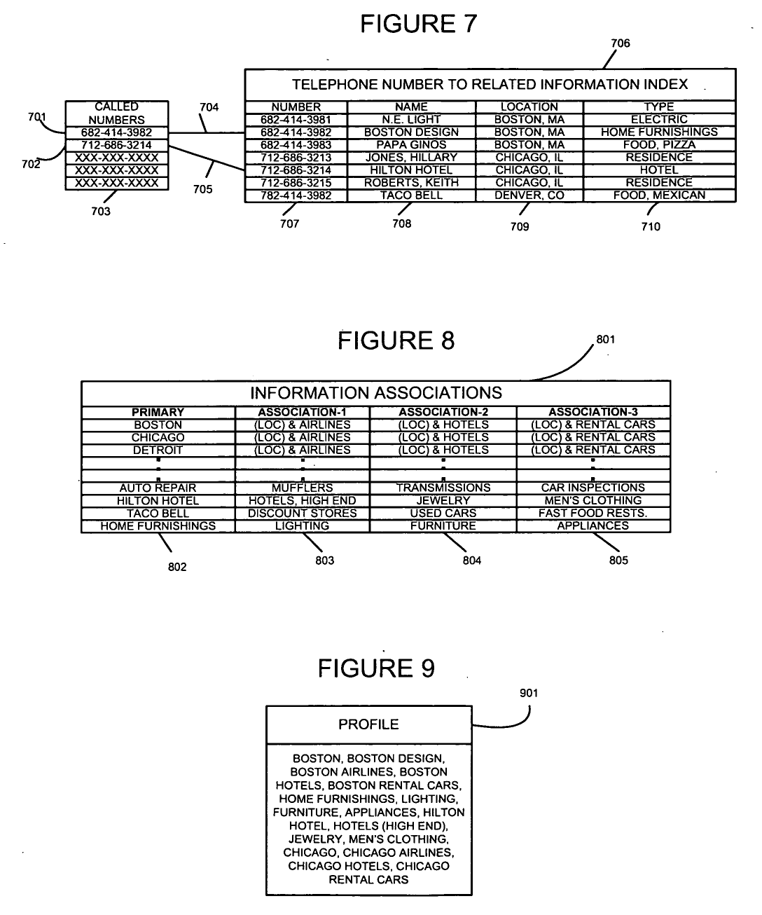

FIG. 7 shows a data file 703 which is an example of the called numbers 510 of FIG. 5. Also depicted is a data file 706 which is representative of the index 530 of FIG. 5. By using the called numbers 703 to look up information in the index 706, call-derived information may be obtained to populate the user or device profile. Data file 706 is a preexisting set of data relating various pieces of information with all (or selected) telephone numbers. For each number 707, the associated information might include the name 708 associated with the number, the location 709 of the person or business, and the type 710 of the listing or business.

For example, on FIG. 7 the called number on line 701 is “682-414-3982”, and is used to look up (See line 704.), via the corresponding number in column 707 of index 706, related information. This results in the derived information for that number; including the name “Boston Design” from column 708, the location “Boston, Mass.” from column 709, and type “Home Furnishings” from column 710.

The called number on line 702 is “712-666-3214”, and is used to look up related information (See line 705.), via the corresponding number in column 707 of the index 706, related information. This results in the derived information for that number; including the name “Hilton Hotel” from column 708, the location “Chicago, Ill.” from column 709, and type “Hotel” from column 710. These six pieces of derived information for the two called numbers could comprise (a part of) a profile for the client device (and/or for the user of the client device, if known). (Recall, e.g., call-derived information 540 of FIG. 5).

Although not shown, the index 706 might include a column for the store's (or organization's, or person's) Website, which might be determined as described above. Indeed, the index 706 might include a column for “related” Websites (e.g., those that include one or more references to the Website of the store, organization, person, etc.).

FIG. 8 shows a data table 801 which contains further related information corresponding to the derived information from FIG. 7. (Recall e.g., 582 of FIG. 5.) For example, the derived location for the first called number is “Boston”. Matching entry “Boston” in column 802 of table 801, may be used to lookup various associated information. Column 803 yields “(LOC) & AIRLINES”. This could be interpreted as the term “Boston airlines”. Column 804 would similarly yield “Boston hotels”, and column 805 would yield “Boston rental cars”. Other examples of information associated with “Boston” might be “American History”, “Boston Massacre”, “Boston Tea Party”, “Massachusetts”, “Concord”, “Cambridge”, “Logan International Airport”, “Charles River”, “Boston Harbor”, “Celtics”, Bruins”, “Red Sox”, etc.

In the same way, applying the location of the second called number from column 709 of table 706 (“Chicago, Ill.”) would yield “Chicago airlines”, “Chicago hotels”, and “Chicago rental cars” from table 801. These terms could be added to the profile built from table 706. Other examples of information associated with “Chicago” might be “Second City”, “Windy City”, “Lake Michigan”, “Illinois”, “Sears Tower”, “O'Hare International Airport”, “Bulls”, “White Sox”, “Bears”, etc.

Further related information in data table 801 could include a listing in column 802 for “Hilton Hotel”, which might have “high-end” shopping options associated with one who stays in such a hotel. For example, column 803 might yield “hotels, high end” to trigger a search for ads related to expensive hotels. Column 804 might yield “jewelry”, and column 805 could yield “men's clothing”. Each of these terms could be used to target those types of ads to the user of device 301, if these terms were included in the profile. Other examples of information associated with Hilton Hotel might be “reservations”, “weddings”, “resorts”, “spas”, etc. These types of attributes can be entered manually, and/or automatically derived. In the latter case, automated classification techniques that classify Websites into predefined categories of interest might be used. For example, techniques described in Andrew McCallum and Kamal Nigam, “A Comparison of Event Models for Naive Bayes Text Classification,” AAAI/ICML-98 Workshop on Learning for Text Categorization, pp. 41-48, Technical Report WS-98-05. AAAI Press (1998), Kamal Nigam, Andrew McCallum, Sebastian Thrun, Tom Mitchell, “Text Classification from Labeled and Unlabeled Documents using EM” Machine Learning, 39(2/3), pp. 103-134 (2000), T. Joachims, “Text Categorization with Support Vector Machines: Learning with Many Relevant Features,” Proceedings of the European Conference on Machine Learning (ECML), Springer (1998), H. Lodhi, C. Saunders, J. Shawe-Taylor, N. Cristianini and C. Watkins, “Text Classification using String Kernels,” Journal of Machine Learning Research, Vol. 2, Pages 419-444, (2002), etc. might be used.

Similarly, the type “home furnishings” from column 710 of table 706 could yield related terms, such as “lighting”, “furniture”, and “appliances” using data table 801. Again, these terms could be added to the profile for device 301 (and/or the user of device 301).

Although the foregoing example showed related information stored in a table, other information expansion techniques might be used. For example, the term “Boston” might be entered as a search query and the top (N) search results could be analyzed to determine related information. As another example, the term “Boston” might be entered as a search term in an online encyclopedia and the entry for Boston could be analyzed to obtain related information. Other information expansion techniques might be used instead, or in addition.

FIG. 9 depicts a possible profile derived from just the two called numbers of table 703, as discussed above. This level of information might be referred to as a “heavy-weight” profile, whereas a profile derived just from the call derived information of table 706 might be referred to as a “light-weight” profile. A light-weight profile might be stored on the client device, whereas a heavy-weight profile might more advantageously be stored at a remote location. Of course, any type of profile may be stored in any suitable location.

### §4.5 CONCLUSIONS

As can be appreciated from the foregoing, embodiments consistent with the present invention can be used to improve the effectiveness of ad placements so that they are better for users and advertisers. Illustratively, methods, apparatus and data structures were described which use numbers (e.g., telephone, SMS, etc.) called from a client device to select and/or score ads to be served to the client device, and/or to a user associated with the client device. Such call-derived information might be used in concert with other information evidencing a user interest (e.g., a search query, requested content, etc.), but might be particularly useful when such other information is not available.

What is claimed is:

1. A computer-implemented method comprising:
a) storing a set of one or more numbers called by a client device;
b) determining call-derived information using the stored set of one or more called numbers; and
c) determining a set of one or more ads to serve using the determined call-derived information.

2. The computer-implemented method of claim 1 wherein the act of determining call-derived information includes using the stored set of one or more called numbers to look up directory information.

3. The computer-implemented method of claim 2 wherein the directory information includes a name of the called party.

4. The computer-implemented method of claim 3 wherein the name of the called party is one of (A) a business name, (B) an organization name, (C) a person's surname, and (D) a person's given name.

5. The computer-implemented method of claim 2 wherein the act of determining call-derived information further includes using the directory information to determine related information.

6. The computer-implemented method of claim 5 wherein the related information is determined using information inference.

7. The computer-implemented method of claim 5 wherein the related information is determined using information expansion.

8. The computer-implemented method of claim 1 further comprising:
d) serving the determined a set of one or more ads to the client device.

9. The computer-implemented method of claim 8 wherein the client device is a Web-phone.

10. The computer-implemented method of claim 1 wherein the client device is associated with a user, the method further comprising:
d) serving the determined a set of one or more ads to the user for rendering on a second client device other than the client device.

11. The computer-implemented method of claim 10 wherein the second client device is a Web device with telephony functionality.

12. The computer-implemented method of claim 10 wherein the second client device is a Web device without telephony functionality.

13. The computer-implemented method of claim 1 wherein the act of determining call-derived information includes weighting the call-derived information, and
wherein the act of determining a set of one or more ads to serve uses the determined weighted call-derived information.

14. The computer-implemented method of claim 13 wherein the call-derived information is weighted using at least one of (A) a duration of a call from which the call-derived information was determined, (B) a cost of a call from which the call-derived information was determined, (C) a frequency that a called number was called, from which the call-derived information was determined, (D) a time lapsed since the call, from which the called-derived information was determined, was last called, (E) a frequency of calls to the same number, (F) a number of calls to the same number, (G) a frequency of calls to a type of person, (H) a frequency of calls to a type of organization, (I) a frequency of calls to a type of business, (J) a number of calls to a type of person, and (K) a number of calls to a type of organization, and (L) a number of calls to a type of business.

15. The computer-implemented method of claim 1 wherein the act of determining call-derived information includes determining a location from the area code of at least one of the stored set of one or more called numbers.

16. The computer-implemented method of claim 1 wherein at least one of the called numbers from the set of called numbers is a telephone number.

17. The computer-implemented method of claim 1 wherein at least one of the called numbers from the set of called numbers is a short message service number.

18. The computer-implemented method of claim 1 wherein the act of determining a set of one or more ads to serve using the determined call-derived includes matching terms of the call-derived information with targeting keywords associated, as a serving constraint, with an advertisement to be served.

19. The computer-implemented method of claim 1 wherein more than one called telephone number is obtained, and the called-derived information includes information related to any of the called telephone numbers.

20. The computer-implemented method of claim 1 wherein at least one of the set of one or more advertisement is an audio advertisement.

21. The computer-implemented method of claim 1 wherein the obtained information includes at least one of (A) a description of a business associated with a called number, and (B) a description of an organization associated with a called number.

22. Apparatus comprising:
a) means for storing a set of one or more numbers called by a client device;
b) means for determining call-derived information using the stored set of one or more called numbers; and
c) means for determining a set of one or more ads to serve using the determined call-derived information.

23. The apparatus of claim 22 further comprising:
d) means for serving the determined a set of one or more ads to the client device.

24. The apparatus of claim 22 wherein the client device is associated with a user, the apparatus further comprising:
d) means for serving the determined a set of one or more ads to the user for rendering on a second client device other than the client device.
